(19) United States
(12) Patent Application Publication
(10) Pub. No.: US 2025/0196332 A1
(43) Pub. Date: Jun. 19, 2025

(54) ROBOTIC MANIPULATION OF OBJECTS

(71) Applicant: Boston Dynamics, Inc., Waltham, MA (US)

(72) Inventors: Kevin Doherty, Somerville, MA (US); Alberto Rodriguez, Cambridge, MA (US)

(21) Appl. No.: 18/541,239

(22) Filed: Dec. 15, 2023

(51) Int. Cl. B25J 9/16; B25J 13/08

(52) U.S. Cl. CPC B25J 9/1612; B25J 9/161; B25J 9/163; B25J 9/1633; B25J 9/1697; B25J 13/089

(57) ABSTRACT

A computing system of a robot receives robot data reflecting at least a portion of the robot, and object data reflecting at least a portion of an object, the object data determined based on information from at least two sources. The computing system determines, based on the robot data and the object data, a set of states of the object, each state in the set of states associated with a distinct time at which the object is at least partially supported by the robot. The set of states includes at least three states associated with three distinct times. The computing system instructs the robot to perform a manipulation of the object based, at least in part, on at least one state in the set of states.

### TECHNICAL FIELD

This disclosure relates generally to robotics and more specifically to systems, methods and apparatuses, including computer programs, for manipulating objects using robotic devices.

### BACKGROUND

Robotic devices are being developed for a variety of purposes today, such as to advance foundational research and to assist with missions that may be risky or taxing for humans to perform. Over time, robots have been tasked with increasingly complicated tasks, such as manipulation of objects. Robots can benefit from improved schemes to perceive and/or track manipulated objects to assist in performing manipulation tasks.

### SUMMARY

The present invention includes systems, methods and apparatuses, including computer programs, for manipulating objects using robotic devices. A robot can manipulate (e.g., grasp, re-grasp, or place) one or more objects by taking into account multiple sources and/or types of object data (e.g., vision, kinematic, and/or force feedback data) to determine a state (e.g., a position and an orientation) of the one or more objects at one or more times. The robot can use this state information to determine one or more suitable manipulation strategies for the one or more objects (e.g., given one or more objectives at runtime, such as a desired state, location, and/or pose of the one or more objects).

In some prior robotic devices, attempting to estimate an object's state based on only one source or type of object data has created challenges. For example, attempting to estimate the state of an object based solely on a vision model may be ineffective when there are self-occlusions (e.g., when the robot's end effector prevents a direct view of the object), incomplete views (e.g., when the object is partially or completely out of the vision sensor's field of view), and/or time delays (e.g., when the object has moved in the time it takes a vision-based machine learning algorithm to process an image). As another example, attempting to estimate the state of an object based solely on a kinematic model may make it difficult or impossible to determine the motion of a grasped object under less than ideal conditions (e.g., when the object slips in the end effector's grasp, and/or when an unsensed gripper compliance conforms to the object).

By taking into account multiple sources and/or types of object data, and/or representing such information with a state function that evolves in time and/or stays current to a high degree of accuracy, more reliable estimates of the object's state can be determined (e.g., by prioritizing and/or relying upon one source of data when a different source of data is occluded, time-delayed, or offline). In addition, multiple kinematic parameters of interest (e.g., an object's pose relative to a robot's end effector(s)) and/or inertial parameters (e.g., an object's mass and/or center of mass) can be inferred. In some embodiments, a parameter reflecting an uncertainty in the object's state can be determined (and/or utilized in further manipulation planning). In some embodiments, unreliable data received from one or more object data sources can be discarded (e.g., when one feedback source is occluded, or when one feedback source produces a spurious outlier). In some embodiments, one or more modules used to track the object's state can flexibly incorporate new data sources and/or track new aspects of the object's state. In some embodiments, the one or more modules can be implemented as an intermediate software layer (e.g., between perception and control functions) in a software stack that supports the determination of suitable robotic movements.

In one aspect, the invention features a computer-implemented method. The method includes receiving, by a computing system of a robot, robot data reflecting at least a portion of the robot. The method also includes receiving, by the computing system of the robot, object data reflecting at least a portion of an object. The object data is determined based on information from at least two sources. The method also includes determining, by the computing system, based on the robot data and the object data, a set of states of the object. Each state in the set of states is associated with a distinct time at which the object is at least partially supported by the robot. The set of states includes at least three states associated with three distinct times. The method also includes instructing, by the computing system, the robot to perform a manipulation of the object based, at least in part, on at least one state in the set of states.

In some embodiments, the at least two sources include at least two of vision, kinematic, or force feedback information. In some embodiments, at least one state in the set of states comprises a position and an orientation of the object. In some embodiments, at least one state in the set of states comprises a mass of the object. In some embodiments, at least one state in the set of states comprises a center of mass of the object. In some embodiments, at least one state in the set of states comprises an inertial distribution of the object. In some embodiments, at least one state in the set of states comprises a six-dimensional pose of the object. In some embodiments, the method further comprises determining the six-dimensional pose using a machine learning model. In some embodiments, the method further comprises determining the six-dimensional pose based on output of a kinematic state estimation module of the computing system. In some embodiments, the object is at least partially supported by the robot when the object is held, grasped, balanced, or otherwise maintained in a spatial region (e.g., against a countervailing force, such as gravity) by at least a portion of the robot (e.g., one or more end effectors of the robot). In some embodiments, the object is at least partially supported by the robot when the robot bears at least a portion of a weight of the object. In some embodiments, the object is at least partially supported by the robot when the object remains (or substantially remains) in a certain position and/or orientation at least partially because of a force applied by the robot (e.g., when the robot is grasping the object, the object would fall to the ground but for the robot's grasping the object).

In some embodiments, determining the set of states is performed using a probabilistic model implemented in an object state estimation module of the computing system. In some embodiments, determining the set of states is performed using a factor graph. In some embodiments, a first state in the set of states comprises a past state of the object. In some embodiments, a second state in the set of states comprises a current state of the object. In some embodiments, at least one state in the set of states comprises a time adjustment of object data based on at least one source. In some embodiments, the time adjustment is based on at least one of a delay associated with the at least one source (e.g., a latency or a delay in receipt of object data) or a processing time of the computing device. In some embodiments, determining a first state of the object associated with a first time comprises integrating object data received at a later time.

In some embodiments, the at least one source includes a source that provides intermittent data. In some embodiments, each state in the set of states is determined relative to a global coordinate reference frame. In some embodiments, each state in the set of states is determined relative to each of one or more end effectors of the robot. In some embodiments, the manipulation includes at least one of grasping, re-grasping, or placing. In some embodiments, determining at least one state in the set of states comprises rejecting anomalous data from at least one object data source. In some embodiments, determining at least one state in the set of states comprises determining that object data from at least one source is occluded or incomplete. In some embodiments, determining at least one state in the set of states comprises instructing action by the robot to gather additional data.

In some embodiments, determining at least one state in the set of states comprises inferring one or more kinematic parameters of the object. In some embodiments, the method further comprises determining the one or more kinematic parameters of the object based on kinematic information from two or more end effectors of the robot. In some embodiments, determining the set of states comprises inferring one or more inertial parameters of the object. In some embodiments, determining at least one state in the set of states comprises determining an uncertainty associated with at least one state in the set of states. In some embodiments, the uncertainty is based on an estimate of a covariance of a pose of the object. In some embodiments, determining the states in the set of states is performed in an intermediate software layer of the computing device.

In some embodiments, the intermediate software layer is situated between a software layer associated with receiving the object data and a software layer associated with instructing the robot to perform the manipulation. In some embodiments, the set of states includes at least five states associated with five distinct times. In some embodiments, the set of states includes at least ten states associated with ten distinct times. In some embodiments, the set of states includes a different number of states associated with a corresponding number of distinct times, including 20, 30, 40, 50, 100, or another number. In some embodiments, the object data reflects an interaction between the robot and the object.

In another aspect, the invention features a computing system of a robot. The computing system comprises data processing hardware and memory hardware in communication with the data processing hardware. The memory hardware stores instructions that when executed on the data processing hardware cause the data processing hardware to perform operations. The operations include receiving robot data reflecting at least a portion of the robot. The operations include receiving object data reflecting at least a portion of an object. The object data is determined based on information from at least two sources. The operations include determining, based on the robot data and the object data, a set of states of the object. Each state in the set of states is associated with a distinct time at which the object is at least partially supported by the robot. The set of states includes at least three states associated with three distinct times. The operations include instructing the robot to perform a manipulation of the object based, at least in part, on at least one state in the set of states.

In some embodiments, the at least two sources include at least two of vision, kinematic, or force feedback information. In some embodiments, at least one state in the set of states comprises a position and an orientation of the object. In some embodiments, at least one state in the set of states comprises a mass of the object. In some embodiments, at least one state in the set of states comprises a center of mass of the object. In some embodiments, at least one state in the set of states comprises an inertial distribution of the object. In some embodiments, at least one state in the set of states comprises a six-dimensional pose of the object. In some embodiments, the operations further include determining the six-dimensional pose using a machine learning model. In some embodiments, the operations further include determining the six-dimensional pose based on output of a kinematic state estimation module of the computing system. In some embodiments, the object is at least partially supported by the robot when the object is held, grasped, balanced, or otherwise maintained in a spatial region (e.g., against a countervailing force, such as gravity) by at least a portion of the robot (e.g., one or more end effectors of the robot). In some embodiments, the object is at least partially supported by the robot when the robot bears at least a portion of a weight of the object. In some embodiments, the object is at least partially supported by the robot when the object remains (or substantially remains) in a certain position and/or orientation at least partially because of a force applied by the robot (e.g., when the robot is grasping the object, the object would fall to the ground but for the robot's grasping the object).

In some embodiments, determining each state in the set of states is performed using a probabilistic model implemented in an object state estimation module of the computing system. In some embodiments, determining each state in the set of states is performed using a factor graph. In some embodiments, a first state in the set of states comprises a past state of the object. In some embodiments, a second state in the set of states comprises a current state of the object. In some embodiments, at least one state in the set of states comprises a time adjustment of object data based on at least one source. The time adjustment is based on at least one of a delay associated with the at least one source or a processing time of the computing device. In some embodiments, determining a first state of the object associated with a first time comprises integrating object data received at a later time.

In some embodiments, the at least one source includes a source that provides intermittent data. In some embodiments, each state in the set of states is determined relative to a global coordinate reference frame. In some embodiments, each state in the set of states is determined relative to each of one or more end effectors of the robot. In some embodiments, the manipulation includes at least one of grasping, re-grasping, or placing. In some embodiments, determining at least one state in the set of states comprises rejecting anomalous data from at least one object data source. In some embodiments, determining at least one state in the set of states comprises determining that object data from at least one source is occluded or incomplete. In some embodiments, determining at least one state in the set of states comprises instructing action by the robot to gather additional data.

In some embodiments, determining at least one state in the set of states comprises inferring one or more kinematic parameters of the object. In some embodiments, the operations further include determining the one or more kinematic parameters of the object based on kinematic information from two or more end effectors of the robot. In some embodiments, determining at least one state in the set of states comprises inferring one or more inertial parameters of the object. In some embodiments, determining at least one state in the set of states comprises determining an uncertainty associated with the respective state. In some embodiments, the uncertainty is based on an estimate of a covariance of a pose of the object.

In some embodiments, determining the set of states is performed in an intermediate software layer of the computing device. In some embodiments, the intermediate software layer is situated between a software layer associated with receiving the object data and a software layer associated with instructing the robot to perform the manipulation. In some embodiments, the set of states includes at least five states associated with five distinct times. In some embodiments, the set of states includes at least ten states associated with ten distinct times. In some embodiments, the set of states includes a different number of states associated with a corresponding number of distinct times, including 20, 30, 40, 50, 100, or another number. In some embodiments, the object data reflects an interaction between the robot and the object.

In another aspect, the invention features a robot. The robot includes data processing hardware and memory hardware in communication with the data processing hardware. The memory hardware stores instructions that when executed on the data processing hardware cause the data processing hardware to perform operations. The operations include receiving robot data reflecting at least a portion of the robot. The operations include receiving object data reflecting at least a portion of an object. The object data is determined based on information from at least two sources. The operations include determining, based on the robot data and the object data, a set of states of the object. Each state in the set of states is associated with a distinct time at which the object is at least partially supported by the robot. The set of states includes at least three states associated with three distinct times. The operations include instructing the robot to perform a manipulation of the object based, at least in part, on at least one state in the set of states.

In some embodiments, the at least two sources include at least two of vision, kinematic, or force feedback information. In some embodiments, at least one state in the set of states comprises a position and an orientation of the object. In some embodiments, at least one state in the set of states comprises a mass of the object. In some embodiments, at least one state in the set of states comprises a center of mass of the object. In some embodiments, at least one state in the set of states comprises an inertial distribution of the object. In some embodiments, at least one state in the set of states comprises a six-dimensional pose of the object. In some embodiments, the operations further include determining the six-dimensional pose using a machine learning model. In some embodiments, the operations further include determining the six-dimensional pose based on output of a kinematic state estimation module of the computing system. In some embodiments, the object is at least partially supported by the robot when the object is held, grasped, balanced, or otherwise maintained in a spatial region (e.g., against a countervailing force, such as gravity) by at least a portion of the robot (e.g., one or more end effectors of the robot). In some embodiments, the object is at least partially supported by the robot when the robot bears at least a portion of a weight of the object. In some embodiments, the object is at least partially supported by the robot when the object remains (or substantially remains) in a certain position and/or orientation at least partially because of a force applied by the robot (e.g., when the robot is grasping the object, the object would fall to the ground but for the robot's grasping the object).

In some embodiments, determining each state in the set of states is performed using a probabilistic model implemented in an object state estimation module of the computing system. In some embodiments, determining each state in the set of states is performed using a factor graph. In some embodiments, a first state in the set of states comprises a past state of the object. In some embodiments, a second state in the set of states comprises a current state of the object. In some embodiments, at least one state in the set of states comprises a time adjustment of object data based on at least one source. In some embodiments, the time adjustment is based on at least one of a delay associated with the at least one source or a processing time of the computing device. In some embodiments, determining a first state of the object associated with a first time comprises integrating object data received at a later time.

In some embodiments, the at least one source includes a source that provides intermittent data. In some embodiments, each state in the set of states is determined relative to a global coordinate reference frame. In some embodiments, each state in the set of states is determined relative to each of one or more end effectors of the robot. In some embodiments, the manipulation includes at least one of grasping, re-grasping, or placing. In some embodiments, determining at least one state in the set of states comprises rejecting anomalous data from at least one object data source. In some embodiments, determining at least one state in the set of states comprises determining that object data from at least one source is occluded or incomplete. In some embodiments, determining at least one state in the set of states comprises instructing action by the robot to gather additional data.

In some embodiments, determining at least one state in the set of states comprises inferring one or more kinematic parameters of the object. In some embodiments, the operations further include determining the one or more kinematic parameters of the object based on kinematic information from two or more end effectors of the robot. In some embodiments, determining at least one state in the set of states comprises inferring one or more inertial parameters of the object. In some embodiments, determining at least one state in the set of states comprises determining an uncertainty associated with the respective state. In some embodiments, the uncertainty is based on an estimate of a covariance of a pose of the object.

In some embodiments, determining the set of states is performed in an intermediate software layer of the computing device. In some embodiments, the intermediate software layer is situated between a software layer associated with receiving the object data and a software layer associated with instructing the robot to perform the manipulation. In some embodiments, the set of states includes at least five states associated with five distinct times. In some embodiments, the set of states includes at least ten states associated with ten distinct times. In some embodiments, the set of states includes a different number of states associated with a corresponding number of distinct times, including 20, 30, 40, 50, 100, or another number. In some embodiments, the object data reflects an interaction between the robot and the object.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIG. 1 illustrates an example configuration of a robotic device, according to an illustrative embodiment of the invention.

FIG. 2A illustrates an example of a humanoid robot, according to an illustrative embodiment of the invention.

FIG. 2B illustrates an example of another humanoid robot, according to an illustrative embodiment of the invention.

FIG. 3 illustrates an example computing architecture for a robotic device, according to an illustrative embodiment of the invention.

FIG. 4 illustrates an example object state estimation module for a robotic device, according to an illustrative embodiment of the invention.

FIG. 5 illustrates an exemplary factor graph, according to an illustrative embodiment of the invention.

FIG. 6A is a schematic diagram of a fixed-lag smoothing method used in connection with a factor graph, according to an illustrative embodiment of the invention.

FIG. 6B is a schematic diagram of an example factor graph reflecting an object grasped by one hand of a robotic device, according to an illustrative embodiment of the invention.

FIG. 6C is a schematic diagram of an example factor graph reflecting an object grasped by two hands of a robotic device, according to an illustrative embodiment of the invention.

FIG. 6D is a schematic diagram of the factor graph of FIG. 6C after receiving an additional vision measurement, according to an illustrative embodiment of the invention.

FIG. 7A is an annotated view of a real-world humanoid robot manipulating an object using a kinematic-only object pose estimation algorithm, according to an illustrative embodiment of the invention.

FIG. 7B is an annotated view of a real-world humanoid robot manipulating an object using kinematic object pose estimation data and visual object pose estimation data, according to an illustrative embodiment of the invention.

FIG. 7C is an annotated view of a real-world humanoid robot grasping an object with an end effector having a loose grip on the object, according to an illustrative embodiment of the invention.

FIG. 7D is an annotated view of a real-world humanoid robot re-grasping the object in FIG. 7C with a stronger grip on the object, according to an illustrative embodiment of the invention.

FIGS. 8A-8F are sequential views of a real-world humanoid robot manipulating a compressor, according to an illustrative embodiment of the invention.

FIG. 9 is a flowchart of an exemplary computer-implemented method, according to an illustrative embodiment of the invention.

### DETAILED DESCRIPTION

An example implementation involves a robotic device configured with at least one robotic limb, one or more sensors, and a processing system. The robotic limb may be an articulated robotic appendage including a number of members connected by joints. The robotic limb may also include a number of actuators (e.g., 2-5 actuators) coupled to the members of the limb that facilitate movement of the robotic limb through a range of motion limited by the joints connecting the members. The sensors may be configured to measure properties of the robotic device, such as angles of the joints, pressures within the actuators, joint torques, and/or positions, velocities, and/or accelerations of members of the robotic limb(s) at a given point in time. The sensors may also be configured to measure an orientation (e.g., a body orientation measurement) of the body of the robotic device (which may also be referred to herein as the “base” of the robotic device). Other example properties include the masses of various components of the robotic device, among other properties. The processing system of the robotic device may determine the angles of the joints of the robotic limb, either directly from angle sensor information or indirectly from other sensor information from which the joint angles can be calculated. The processing system may then estimate an orientation of the robotic device based on the sensed orientation of the base of the robotic device and the joint angles.

An orientation may herein refer to an angular position of an object. In some instances, an orientation may refer to an amount of rotation (e.g., in degrees or radians) about three axes. In some cases, an orientation of a robotic device may refer to the orientation of the robotic device with respect to a particular reference frame, such as the ground or a surface on which it stands. An orientation may describe the angular position using Euler angles, Tait-Bryan angles (also known as yaw, pitch, and roll angles), and/or Quaternions. In some instances, such as on a computer-readable medium, the orientation may be represented by an orientation matrix and/or an orientation quaternion, among other representations.

In some scenarios, measurements from sensors on the base of the robotic device may indicate that the robotic device is oriented in such a way and/or has a linear and/or angular velocity that requires control of one or more of the articulated appendages in order to maintain balance of the robotic device. In these scenarios, however, it may be the case that the limbs of the robotic device are oriented and/or moving such that balance control is not required. For example, the body of the robotic device may be tilted to the left, and sensors measuring the body's orientation may thus indicate a need to move limbs to balance the robotic device; however, one or more limbs of the robotic device may be extended to the right, causing the robotic device to be balanced despite the sensors on the base of the robotic device indicating otherwise. The limbs of a robotic device may apply a torque on the body of the robotic device and may also affect the robotic device's center of mass. Thus, orientation and angular velocity measurements of one portion of the robotic device may be an inaccurate representation of the orientation and angular velocity of the combination of the robotic device's body and limbs (which may be referred to herein as the “aggregate” orientation and angular velocity).

In some implementations, the processing system may be configured to estimate the aggregate orientation and/or angular velocity of the entire robotic device based on the sensed orientation of the base of the robotic device and the measured joint angles. The processing system may have stored thereon a relationship between the joint angles of the robotic device and the extent to which the joint angles of the robotic device affect the orientation and/or angular velocity of the base of the robotic device. The relationship between the joint angles of the robotic device and the motion of the base of the robotic device may be determined based on the kinematics and mass properties of the limbs of the robotic devices. In other words, the relationship may specify the effects that the joint angles have on the aggregate orientation and/or angular velocity of the robotic device. Additionally, the processing system may be configured to determine components of the orientation and/or angular velocity of the robotic device caused by internal motion and components of the orientation and/or angular velocity of the robotic device caused by external motion. Further, the processing system may differentiate components of the aggregate orientation in order to determine the robotic device's aggregate yaw rate, pitch rate, and roll rate (which may be collectively referred to as the “aggregate angular velocity”).

In some implementations, the robotic device may also include a control system that is configured to control the robotic device on the basis of a simplified model of the robotic device. The control system may be configured to receive the estimated aggregate orientation and/or angular velocity of the robotic device, and subsequently control one or more jointed limbs of the robotic device to behave in a certain manner (e.g., maintain the balance of the robotic device). For instance, the control system may determine locations at which to place the robotic device's feet and/or the force to exert by the robotic device's feet on a surface based on the aggregate orientation.

In some implementations, the robotic device may include force sensors that measure or estimate the external forces (e.g., the force applied by a leg of the robotic device against the ground) along with kinematic sensors to measure the orientation of the limbs of the robotic device. The processing system may be configured to determine the robotic device's angular momentum based on information measured by the sensors. The control system may be configured with a feedback-based state observer that receives the measured angular momentum and the aggregate angular velocity, and provides a reduced-noise estimate of the angular momentum of the robotic device. The state observer may also receive measurements and/or estimates of torques or forces acting on the robotic device and use them, among other information, as a basis to determine a reduced-noise estimate of the angular momentum of the robotic device.

The control system may be configured to actuate one or more actuators connected across components of a robotic leg. The actuators may be controlled to raise or lower the robotic leg. In some cases, a robotic leg may include actuators to control the robotic leg's motion in three dimensions. Depending on the particular implementation, the control system may be configured to use the aggregate orientation, along with other sensor measurements, as a basis to control the robot in a certain manner (e.g., stationary balancing, walking, running, galloping, etc.).

In some implementations, multiple relationships between the joint angles and their effect on the orientation and/or angular velocity of the base of the robotic device may be stored on the processing system. The processing system may select a particular relationship with which to determine the aggregate orientation and/or angular velocity based on the joint angles. For example, one relationship may be associated with a particular joint being between 0 and 90 degrees, and another relationship may be associated with the particular joint being between 91 and 180 degrees. The selected relationship may more accurately estimate the aggregate orientation of the robotic device than the other relationships.

In some implementations, the processing system may have stored thereon more than one relationship between the joint angles of the robotic device and the extent to which the joint angles of the robotic device affect the orientation and/or angular velocity of the base of the robotic device. Each relationship may correspond to one or more ranges of joint angle values (e.g., operating ranges). In some implementations, the robotic device may operate in one or more modes. A mode of operation may correspond to one or more of the joint angles being within a corresponding set of operating ranges. In these implementations, each mode of operation may correspond to a certain relationship.

The angular velocity of the robotic device may have multiple components describing the robotic device's orientation (e.g., rotational angles) along multiple planes. From the perspective of the robotic device, a rotational angle of the robotic device turned to the left or the right may be referred to herein as “yaw.” A rotational angle of the robotic device upwards or downwards may be referred to herein as “pitch.” A rotational angle of the robotic device tilted to the left or the right may be referred to herein as “roll.” Additionally, the rate of change of the yaw, pitch, and roll may be referred to herein as the “yaw rate,” the “pitch rate,” and the “roll rate,” respectively.

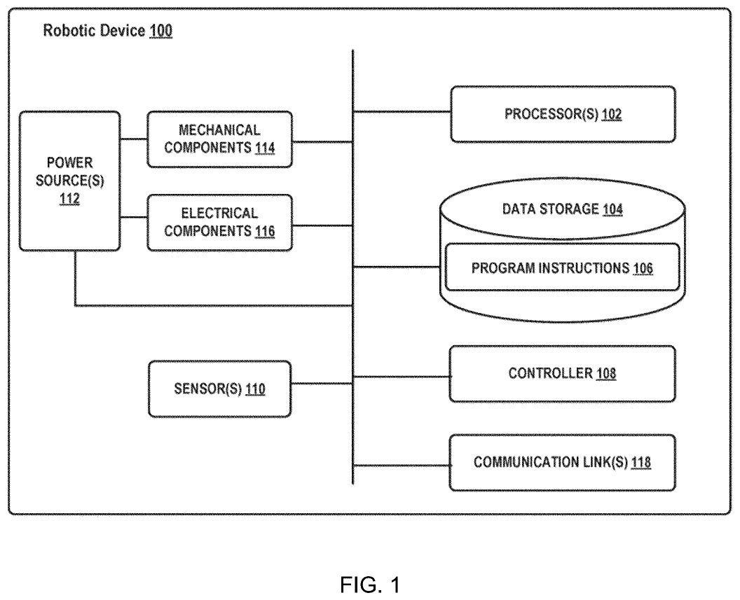

Referring now to the figures, FIG. 1 illustrates an example configuration of a robotic device (or “robot”) 100, according to an illustrative embodiment of the invention. The robotic device 100 represents an example robotic device configured to perform the operations described herein. Additionally, the robotic device 100 may be configured to operate autonomously, semi-autonomously, and/or using directions provided by user(s), and may exist in various forms, such as a humanoid robot, biped, quadruped, or other mobile robot, among other examples. Furthermore, the robotic device 100 may also be referred to as a robotic system, mobile robot, or robot, among other designations.

As shown in FIG. 1, the robotic device 100 includes processor(s) 102, data storage 104, program instructions 106, controller 108, sensor(s) 110, power source(s) 112, mechanical components 114, and electrical components 116. The robotic device 100 is shown for illustration purposes and may include more or fewer components without departing from the scope of the disclosure herein. The various components of robotic device 100 may be connected in any manner, including via electronic communication means, e.g., wired or wireless connections. Further, in some examples, components of the robotic device 100 may be positioned on multiple distinct physical entities rather on a single physical entity. Other example illustrations of robotic device 100 may exist as well.

Processor(s) 102 may operate as one or more general-purpose processor or special purpose processors (e.g., digital signal processors, application specific integrated circuits, etc.). The processor(s) 102 can be configured to execute computer-readable program instructions 106 that are stored in the data storage 104 and are executable to provide the operations of the robotic device 100 described herein. For instance, the program instructions 106 may be executable to provide operations of controller 108, where the controller 108 may be configured to cause activation and/or deactivation of the mechanical components 114 and the electrical components 116. The processor(s) 102 may operate and enable the robotic device 100 to perform various functions, including the functions described herein.

The data storage 104 may exist as various types of storage media, such as a memory. For example, the data storage 104 may include or take the form of one or more computer-readable storage media that can be read or accessed by processor(s) 102. The one or more computer-readable storage media can include volatile and/or non-volatile storage components, such as optical, magnetic, organic or other memory or disc storage, which can be integrated in whole or in part with processor(s) 102. In some implementations, the data storage 104 can be implemented using a single physical device (e.g., one optical, magnetic, organic or other memory or disc storage unit), while in other implementations, the data storage 104 can be implemented using two or more physical devices, which may communicate electronically (e.g., via wired or wireless communication). Further, in addition to the computer-readable program instructions 106, the data storage 104 may include additional data such as diagnostic data, among other possibilities.

The robotic device 100 may include at least one controller 108, which may interface with the robotic device 100. The controller 108 may serve as a link between portions of the robotic device 100, such as a link between mechanical components 114 and/or electrical components 116. In some instances, the controller 108 may serve as an interface between the robotic device 100 and another computing device. Furthermore, the controller 108 may serve as an interface between the robotic device 100 and a user(s). The controller 108 may include various components for communicating with the robotic device 100, including one or more joysticks or buttons, among other features. The controller 108 may perform other operations for the robotic device 100 as well. Other examples of controllers may exist as well.

Additionally, the robotic device 100 includes one or more sensor(s) 110 such as force sensors, proximity sensors, motion sensors, load sensors, position sensors, touch sensors, depth sensors, ultrasonic range sensors, and/or infrared sensors, among other possibilities. The sensor(s) 110 may provide sensor data to the processor(s) 102 to allow for appropriate interaction of the robotic device 100 with the environment as well as monitoring of operation of the systems of the robotic device 100. The sensor data may be used in evaluation of various factors for activation and deactivation of mechanical components 114 and electrical components 116 by controller 108 and/or a computing system of the robotic device 100.

The sensor(s) 110 may provide information indicative of the environment of the robotic device for the controller 108 and/or computing system to use to determine operations for the robotic device 100. For example, the sensor(s) 110 may capture data corresponding to the terrain of the environment or location of nearby objects, which may assist with environment recognition and navigation, etc. In an example configuration, the robotic device 100 may include a sensor system that may include a camera, RADAR, LIDAR, time-of-flight camera, global positioning system (GPS) transceiver, and/or other sensors for capturing information of the environment of the robotic device 100. The sensor(s) 110 may monitor the environment in real-time and detect obstacles, elements of the terrain, weather conditions, temperature, and/or other parameters of the environment for the robotic device 100.

Further, the robotic device 100 may include other sensor(s) 110 configured to receive information indicative of the state of the robotic device 100, including sensor(s) 110 that may monitor the state of the various components of the robotic device 100. The sensor(s) 110 may measure activity of systems of the robotic device 100 and receive information based on the operation of the various features of the robotic device 100, such as the operation of extendable legs, arms, or other mechanical and/or electrical features of the robotic device 100. The sensor data provided by the sensors may enable the computing system of the robotic device 100 to determine errors in operation as well as monitor overall functioning of components of the robotic device 100.

For example, the computing system may use sensor data to determine the stability of the robotic device 100 during operations as well as measurements related to power levels, communication activities, components that require repair, among other information. As an example configuration, the robotic device 100 may include gyroscope(s), accelerometer(s), and/or other possible sensors to provide sensor data relating to the state of operation of the robotic device. Further, sensor(s) 110 may also monitor the current state of a function, such as a gait, that the robotic device 100 may currently be operating. Additionally, the sensor(s) 110 may measure a distance between a given robotic leg of a robotic device and a center of mass of the robotic device. Other example uses for the sensor(s) 110 may exist as well.

Additionally, the robotic device 100 may also include one or more power source(s) 112 configured to supply power to various components of the robotic device 100. Among possible power systems, the robotic device 100 may include a hydraulic system, electrical system, batteries, and/or other types of power systems. As an example illustration, the robotic device 100 may include one or more batteries configured to provide power to components via a wired and/or wireless connection. Within examples, components of the mechanical components 114 and electrical components 116 may each connect to a different power source or may be powered by the same power source. Components of the robotic device 100 may connect to multiple power sources as well.

Within example configurations, any type of power source may be used to power the robotic device 100, such as a gasoline and/or electric engine. Further, the power source(s) 112 may be charged using various types of charging, such as wired connections to an outside power source, wireless charging, combustion, or other examples. Other configurations may also be possible. Additionally, the robotic device 100 may include a hydraulic system configured to provide power to the mechanical components 114 using fluid power. Components of the robotic device 100 may operate based on hydraulic fluid being transmitted throughout the hydraulic system to various hydraulic motors and hydraulic cylinders, for example. The hydraulic system of the robotic device 100 may transfer a large amount of power through small tubes, flexible hoses, or other links between components of the robotic device 100. Other power sources may be included within the robotic device 100.

Mechanical components 114 can represent hardware of the robotic device 100 that may enable the robotic device 100 to operate and perform physical functions. As a few examples, the robotic device 100 may include actuator(s), extendable leg(s) (“legs”), arm(s), wheel(s), one or multiple structured bodies for housing the computing system or other components, and/or other mechanical components. The particular mechanical components 114 used may depend on the design of the robotic device 100 and may also be based on the functions and/or tasks the robotic device 100 may be configured to perform. As such, depending on the operation and functions of the robotic device 100, different mechanical components 114 may be available for the robotic device 100 to utilize. In some examples, the robotic device 100 may be configured to add and/or remove mechanical components 114, which may involve assistance from a user and/or other robotic device. For example, the robotic device 100 may be initially configured with four legs, but may be altered by a user or the robotic device 100 to remove two of the four legs to operate as a biped. Other examples of mechanical components 114 may be included.

The electrical components 116 may include various components capable of processing, transferring, and/or providing electrical charge or electric signals, for example. Among possible examples, the electrical components 116 may include electrical wires, circuitry, and/or wireless communication transmitters and receivers to enable operations of the robotic device 100. The electrical components 116 may interwork with the mechanical components 114 to enable the robotic device 100 to perform various operations. The electrical components 116 may be configured to provide power from the power source(s) 112 to the various mechanical components 114, for example. Further, the robotic device 100 may include electric motors. Other examples of electrical components 116 may exist as well.

In some implementations, the robotic device 100 may also include communication link(s) 118 configured to send and/or receive information. The communication link(s) 118 may transmit data indicating the state of the various components of the robotic device 100. For example, information sensed by sensor(s) 110 may be transmitted via the communication link(s) 118 to a separate device. Other diagnostic information indicating the integrity or health of the power source(s) 112, mechanical components 114, electrical components 116, processor(s) 102, data storage 104, and/or controller 108 may be transmitted via the communication link(s) 118 to an external communication device.

In some implementations, the robotic device 100 may receive information at the communication link(s) 118 that is processed by the processor(s) 102. The received information may indicate data that is accessible by the processor(s) 102 during execution of the program instructions 106, for example. Further, the received information may change aspects of the controller 108 that may affect the behavior of the mechanical components 114 and/or the electrical components 116. In some cases, the received information may indicate a query requesting a particular piece of information (e.g., the operational state of one or more of the components of the robotic device 100), and the processor(s) 102 may subsequently transmit that particular piece of information via the communication link(s) 118.

In some cases, the communication link(s) 118 include a wired connection. The robotic device 100 may include one or more ports to interface the communication link(s) 118 to an external device. The communication link(s) 118 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

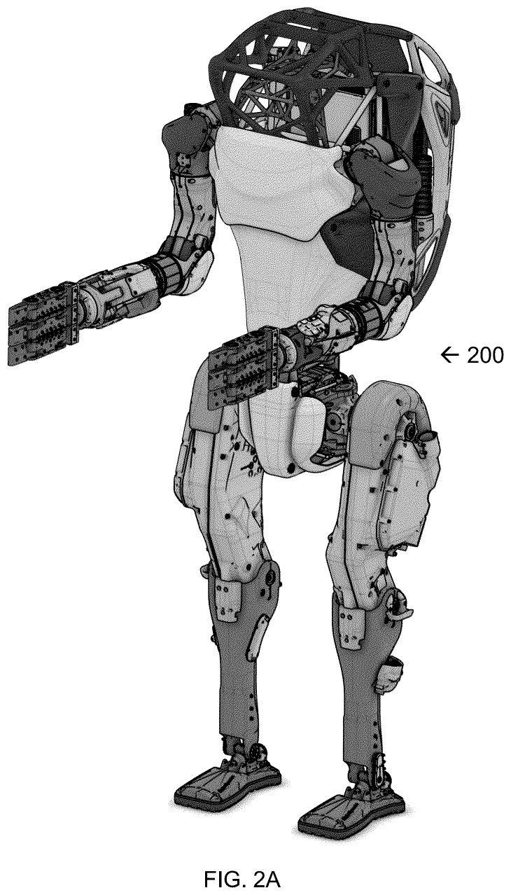

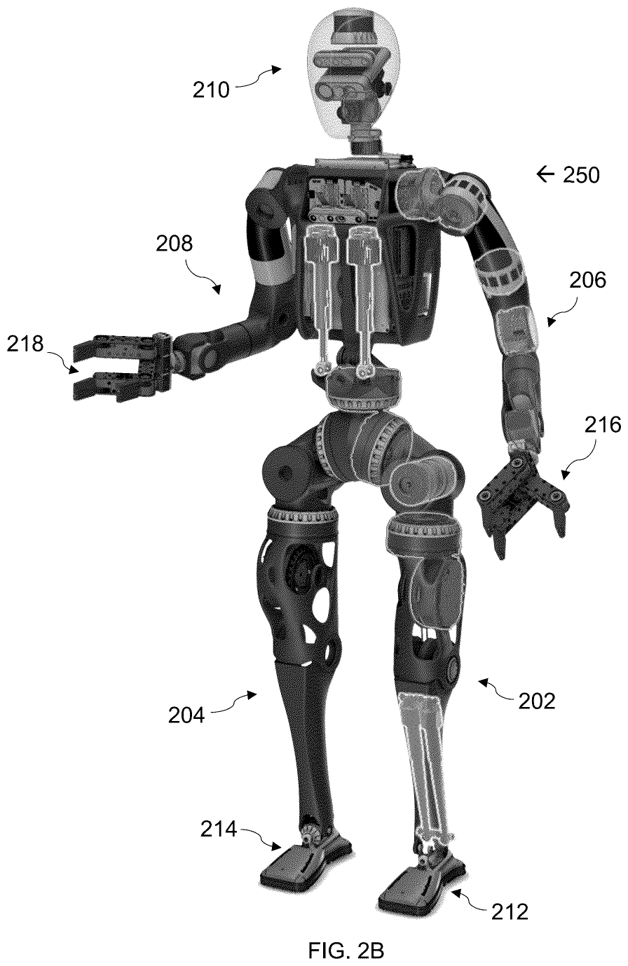

FIG. 2A illustrates an example of a humanoid robot (or robotic device) 200, according to an illustrative embodiment of the invention. The robotic device 200 may correspond to the robotic device 100 shown in FIG. 1. The robotic device 200 serves as a possible implementation of a robotic device that may be configured to include the systems and/or carry out the methods described herein. Other example implementations of robotic devices may exist.

The robotic device 200 may include a number of articulated appendages, such as robotic legs and/or robotic arms. Each articulated appendage may include a number of members connected by joints that allow the articulated appendage to move through certain degrees of freedom. Each member of an articulated appendage may have properties describing aspects of the member, such as its weight, weight distribution, length, and/or shape, among other properties. Similarly, each joint connecting the members of an articulated appendage may have known properties, such as the degrees of its range of motion the joint allows, the size of the joint, and the distance between members connected by the joint, among other properties. A given joint may be a joint allowing one degree of freedom (e.g., a knuckle joint or a hinge joint), a joint allowing two degrees of freedom (e.g., a cylindrical joint), a joint allowing three degrees of freedom (e.g., a ball and socket joint), or a joint allowing four or more degrees of freedom. A degree of freedom may refer to the ability of a member connected to a joint to move about a particular translational or rotational axis.

The robotic device 200 may also include sensors to measure the angles of the joints of its articulated appendages. In addition, the articulated appendages may include a number of actuators that can be controlled to extend and retract members of the articulated appendages. In some cases, the angle of a joint may be determined based on the extent of protrusion or retraction of a given actuator. In some instances, the joint angles may be inferred from position data of inertial measurement units (IMUs) mounted on the members of an articulated appendage. In some implementations, the joint angles may be measured using rotary position sensors, such as rotary encoders. In other implementations, the joint angles may be measured using optical reflection techniques. Other joint angle measurement techniques may also be used.

The robotic device 200 may be configured to send sensor data from the articulated appendages to a device coupled to the robotic device 200 such as a processing system, a computing system, or a control system. The robotic device 200 may include a memory, either included in a device on the robotic device 200 or as a standalone component, on which sensor data is stored. In some implementations, the sensor data is retained in the memory for a certain amount of time. In some cases, the stored sensor data may be processed or otherwise transformed for use by a control system on the robotic device 200. In some cases, the robotic device 200 may also transmit the sensor data over a wired or wireless connection (or other electronic communication means) to an external device.

FIG. 2B illustrates an example of another humanoid robot 250, according to an illustrative embodiment of the invention. The humanoid robot 250 may correspond to the robotic device 100 shown in FIG. 1. The humanoid robot 250 serves as a possible implementation of a robotic device that may be configured to include the systems and/or carry out the methods described herein, but other implementations are also possible.

The humanoid robot 250 may include a number of articulated appendages, such as robotic legs 202, 204 and/or robotic arms 206, 208. The humanoid robot 250 may also include a robotic head 210, which may contain one or more vision sensors (e.g., cameras, infrared sensors, object sensors, range sensors, etc.). Each articulated appendage may include a number of members connected by joints that allow the articulated appendage to move through certain degrees of freedom. For example, each robotic leg 202, 204 may include a respective foot 212, 214, which may contact a surface (e.g., a ground surface). The legs 202, 204 may enable the robot 250 to travel at various speeds according to various gaits. In addition, each robotic arm 206, 208 may facilitate object manipulation, load carrying, and/or balancing of the robot 250. Each arm 206, 208 may also include one or more members connected by joints and may be configured to operate with various degrees of freedom. Each arm 206, 208 may also include a respective end effector (e.g., gripper, hand, etc.) 216, 218. The robot 250 may use end effectors 216, 218 for interacting with (e.g., gripping, turning, pulling, and/or pushing) objects. Each end effector 216, 218 may include various types of appendages or attachments, such as fingers, attached tools or grasping mechanisms.

The robot 250 may also include sensors to measure the angles of the joints of its articulated appendages. In addition, the articulated appendages may include a number of actuators that can be controlled to extend and/or retract members of the articulated appendages. In some embodiments, the angle of a joint may be determined based on the extent of protrusion and/or retraction of a given actuator. In some embodiments, the joint angles may be inferred from position data of inertial measurement units (IMUs) mounted on the members of an articulated appendage. In some embodiments, the joint angles may be measured using rotary position sensors, such as rotary encoders. In some embodiments, the joint angles may be measured using optical reflection techniques. Other joint angle measurement techniques may also be used.

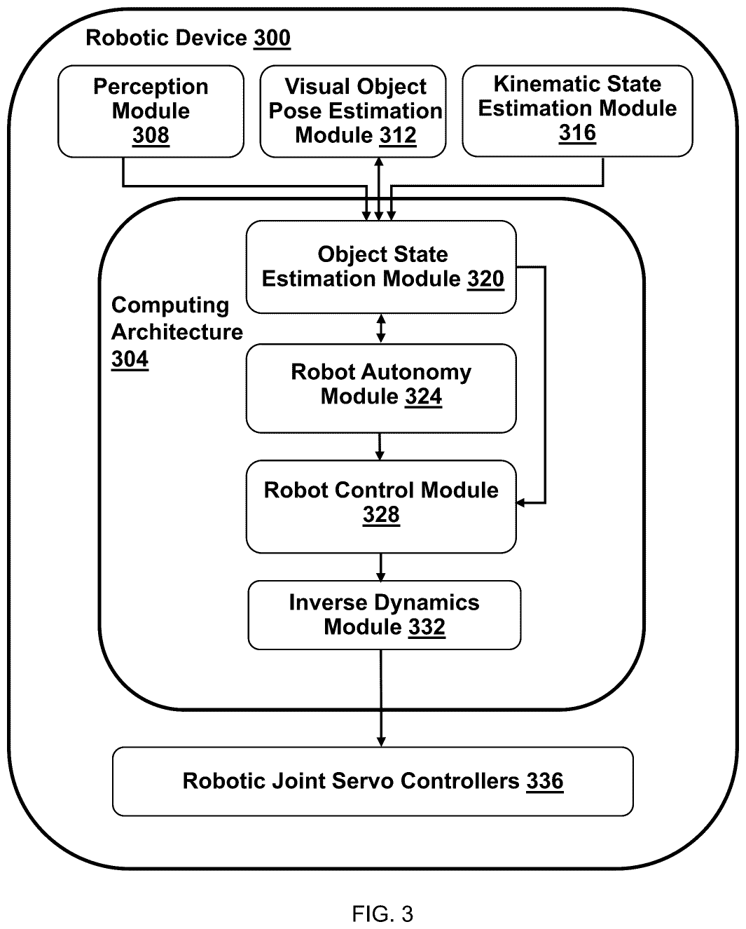

FIG. 3 illustrates an example computing architecture 304 for a robotic device 300, according to an illustrative embodiment of the invention. The computing architecture 304 includes an object state estimation module 320, a robot autonomy module 324, a robot control module 328, and an inverse dynamics module 332. The robotic device 300 also includes a perception module 308, a visual object pose estimation module 312, an object kinematic state estimation module 316, and robotic joint servo controllers 336, which can interact with (e.g., provide input to and/or receive output from) the computing architecture 304. One having ordinary skill in the art will appreciate that the components shown in FIG. 3 are exemplary, and other modules and/or configurations of modules are also possible (for example, in some embodiments, the inverse dynamics module 332 may be included as part of the robot control module 328).

The perception module 308 may be configured to perceive one or more aspects of the environment of the robotic device 300 and/or provide input reflecting the environment to the computing architecture 304 (e.g., to the object state estimation module 320, as shown in FIG. 3). For example, in some embodiments, the perception module 308 can sense aspects of the environment using a RGB camera, a depth camera, a LIDAR or stereo vision device, or another piece of equipment with suitable sensory capabilities. In some embodiments, one or more additional modules (not shown in FIG. 3) can capture other sensory-based input (e.g., force sensing, which may be implemented at one or more end effectors of the robotic device 300), which may provide additional input to the computing architecture 304 (e.g., to the object state estimation module 320).

The visual object pose estimation module 312 may receive information from the object state estimation module 320 (e.g., including one or more images and/or additional information reflecting a grasped object). Based on the received information, the visual object pose estimation module 312 can determine one or more candidate poses for the grasped object, which can be provided to the object state estimation module 320. The kinematic state estimation module 316 may be configured to track kinematic data for the robotic device 300 (e.g., a form of “robot data”) and/or one or more grasped objects (e.g., a form of “object data”). In some embodiments, the kinematic data includes one or more vectors, which may include joint positions, joint velocities, joint accelerations, angular orientations, angular velocities, angular accelerations, sensed forces, or other parameters suitable to characterize the kinematics of the robotic device 300 and/or one or more grasped objects. In some embodiments, the kinematic state estimation module 316 can provide fast feedback rates (e.g., 100-1000 Hz) by comparison to those of the visual object pose estimation module 312 (e.g., 5-50 Hz).

Based on the information received from the perception module 308, the visual object pose estimation module 312, and/or the kinematic state estimation module 316 (and/or other sensory modules not shown in FIG. 3 but described above), the object state estimation module 320 may be configured to determine one or more states of one or more grasped objects (e.g., a state function that evolves over time as new information is received). In some embodiments, a state of each grasped object comprises a position and/or an orientation (e.g., a 6-dimensional or 6D pose). In some embodiments, the object state estimation module 320 may be implemented as an intermediate software layer between perception (e.g., the perception module 308) and control (e.g., the robot control module 328) functions of the robotic device 300. In some embodiments, if and when new information (e.g., new sensors and/or sensor data) becomes available, instead of having to reconfigure communication between perception and control functions, the object state estimation module 320 can be reconfigured to integrate the new information using the same interface. Other sensors may include, but are not limited to, tactile sensors, proximity sensors, or additional cameras (e.g., wrist cameras).

In some embodiments, the object state estimation module 320 may be configured to fuse information from multiple input sources before, during, and/or after a manipulation operation. In some embodiments, the object state estimation module 320 may be configured to include a degree of autonomy to decide when to add and/or remove constraints pertaining to different manipulation stages (e.g., based on the behavior of the robot). For example, the object state estimation module 320 may be configured to decide a time when an end effector grasps an object and/or a time when an object is placed on a surface. In some embodiments, the object state estimation module 320 can be configured to provide an uncertainty associated with one or more object poses. In some embodiments, uncertainty measurements can be determined based on an estimate of the object pose covariance.

The one or more object states determined by the object state estimation module 320 can be provided to the robot autonomy module 324. The robot autonomy module 324 may be configured to determine one or more high-level target robot behaviors (e.g., “walk to the red pole”, “pick up the hammer on the table”, etc.) and provide those target behaviors to the robot control module 328 (e.g., in the form of whole-body robot trajectories or other suitable movement parameters). The one or more object states determined by the object state estimation module 320 can also be provided directly to the robot control module 328 (which may be beneficial, for example, in situations in which the robot control module 328 operates at a higher frequency than the robot autonomy module 324). The robot control module 328 can receive the high-level target robot behaviors and compute specific movements (e.g., whole-body trajectories or other suitable movement parameters) for the robot to perform, while taking into account real-time variations in environmental conditions over time.

The inverse dynamics module 332 can receive output from the robot control module 328 and output a reference joint position and/or torque for each of the robotic joint servo controllers 336, which can be provided to actuators of the robotic device 300 to enable the robotic device 300 to execute its planned movement. In some embodiments, the inverse dynamics module 332 can track a desired wrench of the robotic device 300 as closely as possible or desired in a given situation. In some embodiments, the inverse dynamics module 332 can map a desired robot pose and/or one or more external wrenches to joint torques.

In some embodiments, the visual object pose estimation module 312 comprises a computer program and/or machine learning model to estimate the 6D pose of different objects (e.g., using MegaPose or another 6D pose estimation technique). In some embodiments, the visual object pose estimation module 312 receives one or more camera images. In some embodiments, the visual object pose estimation module 312 also receives one or more masks and/or bounding boxes. In some embodiments, the visual object pose estimation module 312 is configured to execute a coarse model and a refiner. In some embodiments, the visual object pose estimation module 312 is provided one or more initial poses and executes only the refiner on at least one of the one or more initial poses. In some embodiments, the visual object pose estimation module 312 is provided one or more candidate poses and is configured to score each candidate pose, producing a rank-ordered set of candidate poses. In some embodiments, the candidate pose selected can depend on the specific requirements of the problem at hand, e.g., the amount latency and/or processing time that may be tolerated in any given case.

In some embodiments, pose estimates from the visual object pose estimation module 312 can be provided as input (e.g., an input feedback signal) to the object state estimation module 320. For example, the object state estimation module 320 can be configured with a measure of autonomy to decide when visual feedback is useful (e.g., based on whether the object is expected to be visible in the robot's camera), and when it is determined that the visual feedback is useful, object state estimation module 320 may request the pose estimates (or other information) from the visual object pose estimation module 312. In some embodiments, uncertainty estimates can be used to inform future robot behaviors. For example, based on feedback from the object state estimation module 320 that an object's pose is uncertain (e.g., relative to a threshold amount of uncertainty), the robot autonomy module 324 may be configured to initiate an action to attempt to obtain a better view of the object before attempting a precise object manipulation task.

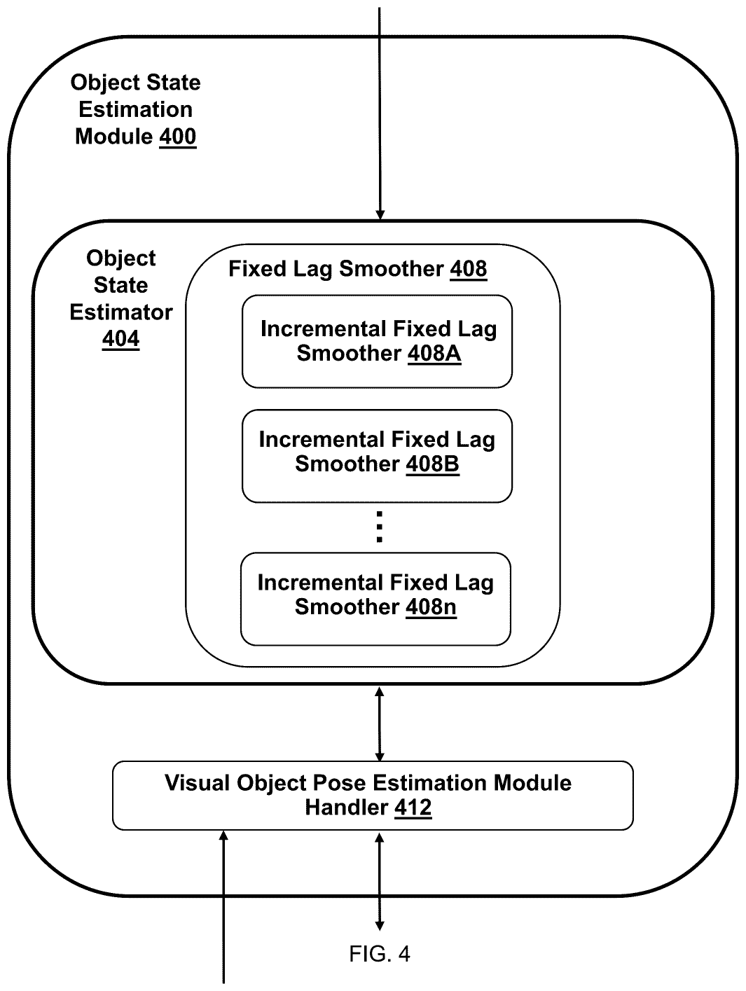

FIG. 4 illustrates an example object state estimation module 400 for a robotic device (e.g., further details of the object state estimation module 320 shown and described above in FIG. 3), according to an illustrative embodiment of the invention. The object state estimation module 400 includes an object state estimator 404 that includes a fixed lag smoother 408 (e.g., comprising incremental fixed lag smoothers 408A, 408B, . . . , 408n, where one incremental fixed lag smoother corresponds to each object in a set of n objects). In some embodiments, the fixed lag smoother 408 is configured to account for relevant time-variant phenomena (e.g., time delays in available feedback signals) to ensure that measured information is associated with the correct corresponding state of the tracked object in time. This accounting can be performed, e.g., by keeping a time window of observations and states longer than the largest relevant time delay, and/or ensuring that the size of the representation used remains bounded in time (e.g., to preserve computational efficiency and/or real-time viability).

In FIG. 4, the object state estimator 404 may receive kinematic state information (e.g., from the kinematic state estimation module 316, shown and described above in FIG. 3). In some embodiments, the kinematic state information may include one or more object states and/or one or more robot body states. The object state estimator 404 may process this information through the fixed lag smoother 408 to estimate each tracked object's state as it evolves in time. In some embodiments, each incremental fixed lag smoother 408A, 408B, . . . , 408n maintains its own history of object states within a suitable time window (e.g., since latching, for a specified period of time in the past, etc.). The object state estimator 404 may provide a state of each of one or more tracked objects (e.g., each of n latched objects) to the visual object pose estimation module handler 412 (e.g., implemented as a MegaPose handler).

This visual object pose estimation module handler 412 may use the state of each of one or more tracked objects to determine whether the visual object pose estimation module (e.g., the visual object pose estimation module 312 shown and described above in FIG. 3) should be sent a request (e.g., implemented as a MegaPose request). Different factors may be considered, e.g., whether the object is the kind of object for which the visual object pose estimation module is expected to provide useful output, or whether the object is sufficiently visible. If the visual object pose estimation module handler 412 sends a request to the visual object pose estimation module, the visual object pose estimation module handler 412 may receive a response (e.g., a candidate set of poses, each with a score, one or more camera images, and/or one or more masks or bounding boxes) from the visual object pose estimation module. The visual object pose estimation module handler 412 may then provide one or more relevant measurements based on the response from the visual object pose estimation module to the object state estimator 404. For example, if the tracked object is believed to be in the camera frame, then it may be desirable to add a vision measurement to the corresponding state in the history of states (although one having ordinary skill in the art will appreciate that the same process could be applied to other kinds of measurements besides vision).

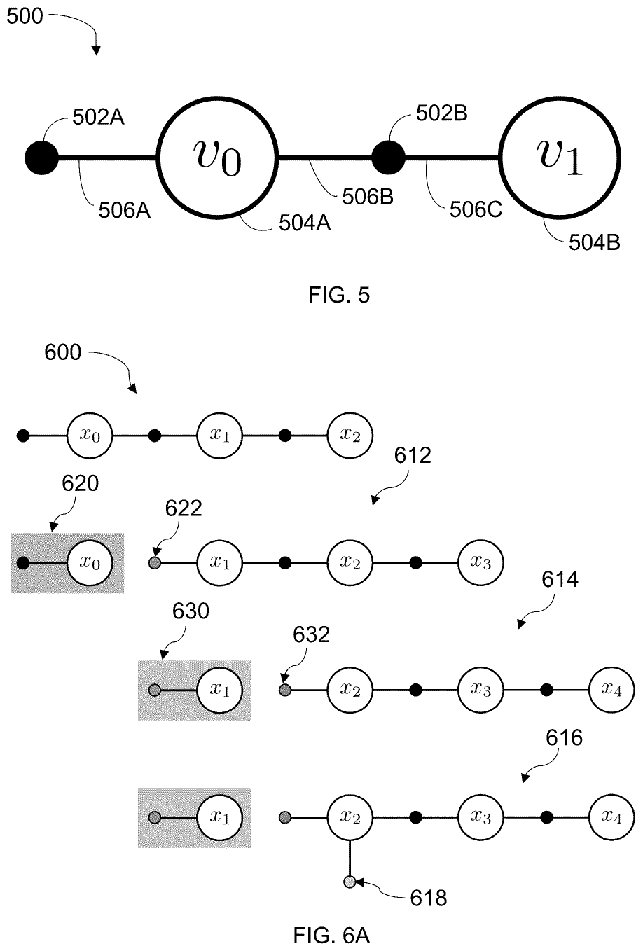

FIG. 5 is a schematic diagram of an exemplary factor graph 500, according to an illustrative embodiment of the invention. A factor graph is one example of a suitable probabilistic model that can be used to represent multiple sources of fused information about an object's state (e.g., vision, kinematics, and/or force feedback information), and/or how the object's state evolves in time. Such an approach affords multiple advantages by comparison to prior methods. First, by permitting a “history” of object states to be maintained, asynchronous and/or time-delayed measurements can be appropriately accounted for in time. Propagating the impact of these measurements to all states of interest in a mathematically precise way stands in contrast to, for example, a pure filtering based approach, which would discard the historical information necessary to handle time-delayed measurements. Second, significant flexibility is afforded in the manner of combining the measurements used. For example, cases in which measurements from a particular source are available only intermittently (e.g., due to occlusions or spurious errors) can be accommodated in real-time and/or de-prioritized when the data is unreliable. Third, significant flexibility is afforded to incorporate new states that are of interest (e.g., mass or inertial properties of an object) and/or new sources or types of measurement information (e.g., output of force-torque sensors). The result can be an object pose estimation signal that is delay-minimized, high-frequency, and/or robust to intermittency of data.

Generally speaking, a factor graph is a graphical representation of a product factorization of a function:

$$f ( V ) = {\prod }_{i} {f}_{i} ( {V}_{i} ) {V}_{i} ⊆ V$$

The following is an example product factorization, which can be represented as the exemplary factor graph 500:

f(V)=f₀(ν₀)f₁(ν₀,ν₁)

As shown in FIG. 5, the factor graph 500 comprises factor nodes 502A, 502B, variable nodes 504A, 504B, and edges 506A, 506B, 506C, which connect pairs of factor nodes and variable nodes as shown. The following restriction can be used to attempt to find a point estimate of V:

$${f}_{i} ( {V}_{i} ) ∝ exp ( - {‖ {r}_{i} ( {V}_{i} ) ‖}_{2}^{2} )$$

Re-arranging this equation:

$$\begin{matrix}{arg max}_{V} f ( V ) = {arg max}_{V} - log f ( V ) \\ = {arg max}_{V} {\sum }_{i} {‖ {r}_{i} ( {V}_{i} ) ‖}_{2}^{2}\end{matrix}$$

If r is differentiable, then a nonlinear least-squares method can be used to attempt to find the point estimate of V (e.g., a maximum-likelihood estimation). In some embodiments, the point estimate of V may correspond to a most likely value of the state of the object (e.g., given past measurements). In some embodiments, the point estimate of V can be used (e.g., by the robot controller) to correct a discrepancy between the current state of the object and a desired state of the object.

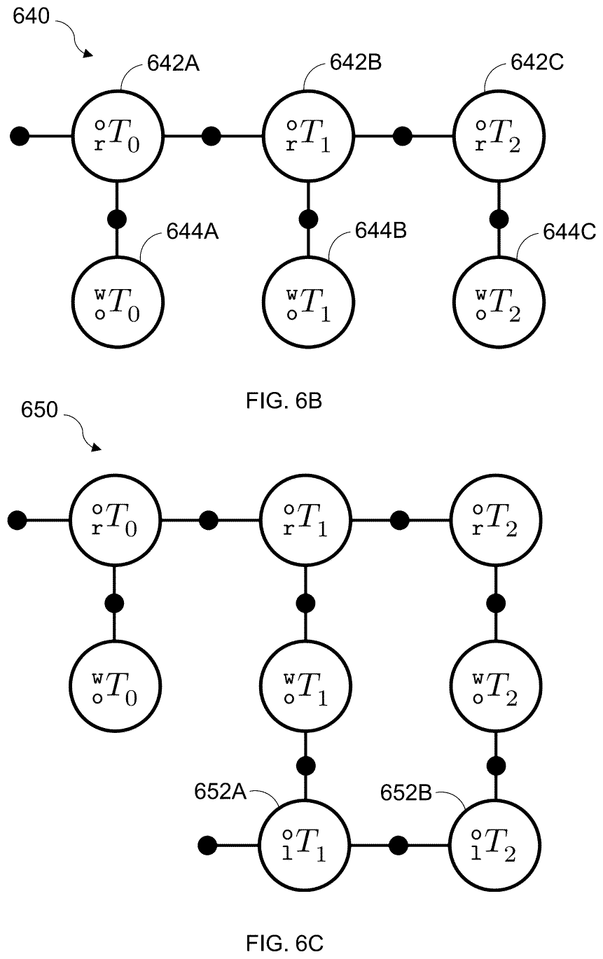

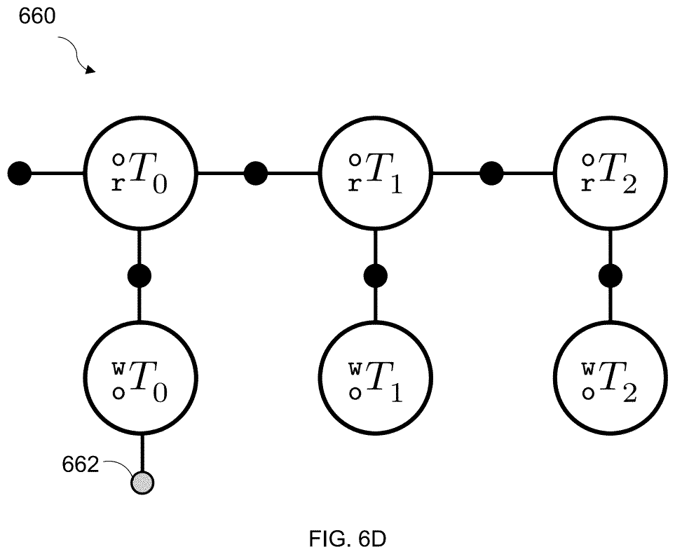

FIG. 6A is a schematic diagram of a fixed-lag smoothing method used in connection with a factor graph 600, according to an illustrative embodiment of the invention. The factor graph 600 includes variable nodes xₜ at t=0, t=1, and t=2. Instead of tracking a state simply at time t, a more expansive history of states is maintained from t-T to t. In FIG. 6A, the window size T is set to 3. When one or more states falls out of window, an approximate marginalization may be performed. For example, in the time iteration illustrated by factor graph 612, in which a variable node x₃ at a fourth time t=3 is added, variables older than t=1 are eliminated (i.e. x₀). This elimination is shown graphically in FIG. 6A, as the box 620 bounding x₀ has been summarized by the new factor node 622. Then, in the time iteration illustrated by factor graph 614, in which a variable node x₄ at a fifth time t=4 is added, variables older than t=2 are eliminated (i.e., x₁). This further elimination is also shown in FIG. 6A, as the box 630 bounding x₁ has been summarized by the new factor node 632. In some embodiments, the approximate marginalization may be identical or essentially identical to an extended Kalman filter. In some embodiments, factor graphs can be linearized, and eliminations can be performed, e.g., using QR or Cholesky decomposition. In some embodiments, the result is a Schur complement. In some embodiments, an inference is performed using a library for nonlinear least squares problems (e.g., GTSAM). In some embodiments, marginalization is performed using one or more tools for manifold optimization and/or incremental inference (e.g., via iSAM2).

In the final time iteration illustrated by factor graph 616, at time t=4, a delayed measurement 618 of x₂ arrives corresponding to time t=2. The factor graph 616 shows how the delayed measurement 618 can be associated with the correct variable node x₂. (Note that if the measurement 618 had instead corresponded to t=1 or earlier, it would be discarded as outside the window T.)

FIG. 6B is a schematic diagram of an example factor graph 640 reflecting an object grasped by one hand (e.g., a right hand only) of a robotic device, according to an illustrative embodiment of the invention. In FIGS. 6B-6D, the following notation applies: 0=object; w=world (vision); r=right hand; 1=left hand; and T=“transform” (e.g., the 6D pose of the object relative to the right hand). For the purposes of FIG. 6B, it is reasonably assumed that the latch pose of an object does not change quickly in time, although it can change. A kinematic measurement reflecting the object's state is made once per period (e.g., every 1 ms, 2 ms, 3 ms, 4 ms, 5 ms, 10 ms, or another interval). The state (e.g., 6D pose) of the object relative to the right hand is tracked from t=0 to t=2 as variable nodes 642A-642C. The object's state (e.g., 6D pose) in the robot world frame (which can be linked by the right hand's 6D pose) is tracked from t=0 to t=2 as variable nodes 644A-644C. In FIG. 6B, purely kinematics measurements (e.g., no vision measurements) are depicted.

FIG. 6C is a schematic diagram of an example factor graph 650 reflecting an object grasped by two hands of a robotic device (e.g., both the left hand and the right hand), according to an illustrative embodiment of the invention. The factor graph 650 is identical to the factor graph 640 except two additional variable nodes 652A, 652B (and corresponding factor nodes and edges) have been added, which reflect data from the left hand of the robot. These variable nodes reflect the left hand latching to the object at t=1 (and staying latched until t=2). In the FIG. 6C instantiation, the factor graph is configured to fuse kinematic information from multiple end effectors, e.g., in a bimanual grasp, with each providing a different constraint on the object pose. FIG. 6C shows how the factor graph topology allows new measurements and/or state variables to be populated online as they arrive. One having ordinary skill in the art will appreciate that the same basic framework can be extended to handle an arbitrary number of end effectors latching at different times. In some embodiments, the object must be latched at a minimum of one end effector for tracking to commence and/or continue (i.e., if the object is fully unlatched from the robot, the robot will stop tracking the object).

FIG. 6D is a schematic diagram of the factor graph of FIG. 6B after receiving (at t=2) an additional vision measurement 682 (captured at time t=0), according to an illustrative embodiment of the invention. The factor graph 660 is identical to the factor graph 640, except that one additional vision measurement 662 (and a corresponding edge) have been added. In FIG. 6D, only a single latch is depicted to avoid visual clutter. In some embodiments, vision measurements that are accepted (e.g., by the visual object pose estimation module handler 412 shown and described above in FIG. 4) are (i) converted from a camera frame to a world frame; (ii) matched (e.g., by time stamp) with a corresponding object transform in the world frame; and/or (iii) added as a new factor to the factor graph (e.g., measurement 662 as shown in FIG. 6D). One having ordinary skill in the art will appreciate that a similar procedure could apply to measurements besides vision measurements.

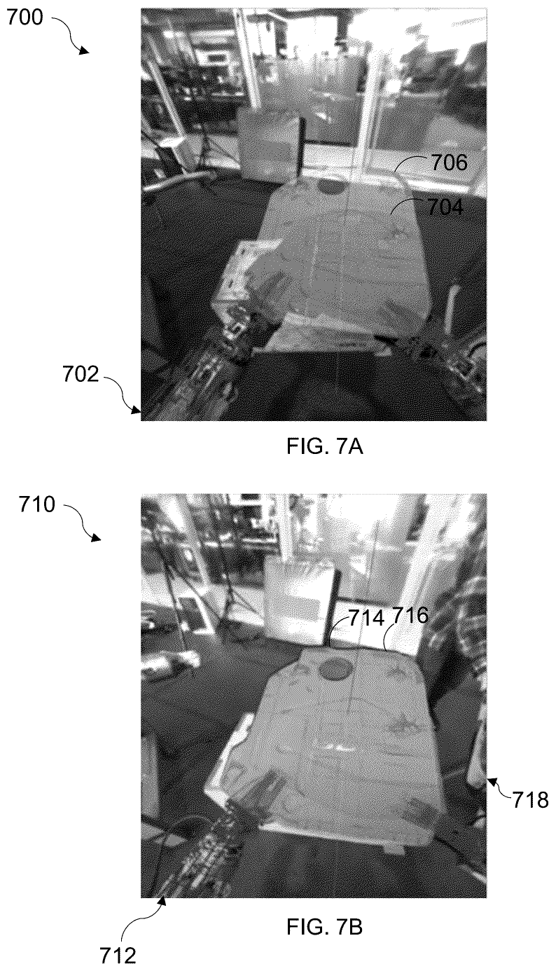

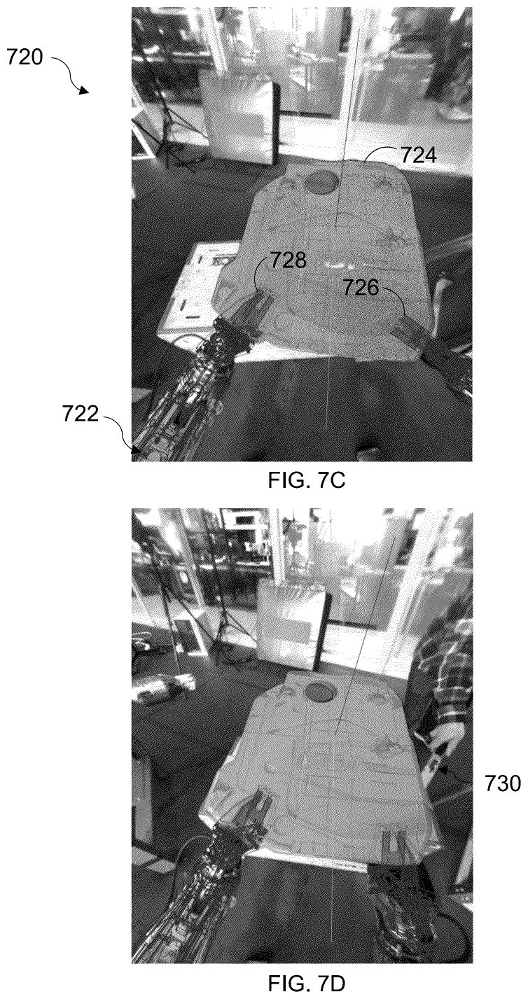

FIG. 7A is an annotated view 700 of a real-world humanoid robot 702 manipulating an object 704 using a kinematic-only object pose estimation algorithm, according to an illustrative embodiment of the invention. The goal of the robot 702 is to manipulate the object 704 such that the 6D pose of the object in the real world corresponds to where the robot believes the object is located, which is represented by the silhouette 706. The silhouette 706 reflects a rendering of a most up-to-date (e.g., current or recent) state estimation of the object 704. In FIG. 7A, the 6D pose of the object 704 does not match the silhouette 706. While in theory the discrepancy could be explained by any number of factors, in this demonstration, before adopting the grasp shown in FIG. 7A, the object 704 was sitting on a table. The robot 702 planned to grasp the object, but in the process of grasping it, perturbed the object slightly (e.g., tilted it in a manner that it did not expect). Using a kinematic-only object pose estimation algorithm, the robot 702 simply remembered where the object 704 was before grasping and used this information to estimate the 6D pose of the object. As it turned out, the estimation, represented by the silhouette 706, did not match the real pose of the object 704.

FIG. 7B is an annotated view 710 of a real-world humanoid robot 712 manipulating an object 714 using kinematic object pose estimation data and visual object pose estimation data, according to an illustrative embodiment of the invention. In the annotated view 710, the object 714 and the silhouette 716 (which, as in FIG. 7A, represents where the robot 712 believes the object is located based on the robot's state estimation procedure) are much better aligned. Visual feedback has been successfully used to improve the estimation accuracy of the 6D pose of the object 714. Also note that in FIG. 7B, the better alignment was maintained in spite of deliberate attempts to misalign the object 714 and the silhouette 716 (e.g., by repeated hits of the object 714 by the hockey stick 718).

FIG. 7C is an annotated view 720 of a real-world humanoid robot 722 grasping an object 724 with an end effector 726 having a loose grip on the object 724, according to an illustrative embodiment of the invention. The other end effector 728 shown has a stronger grip on the object 724. Then, in FIG. 7D, the same object 724 was perturbed by a force external to the robot 722 and object 724, which was in this case provided by the hockey stick 730. As a result, the robot 722 changed its grip in response to the external force and re-grasped the object, which the robot 722 successfully tracked throughout the perturbation (e.g., using an object state estimation module, such as the object state estimation module 320 shown and described above in FIG. 3).

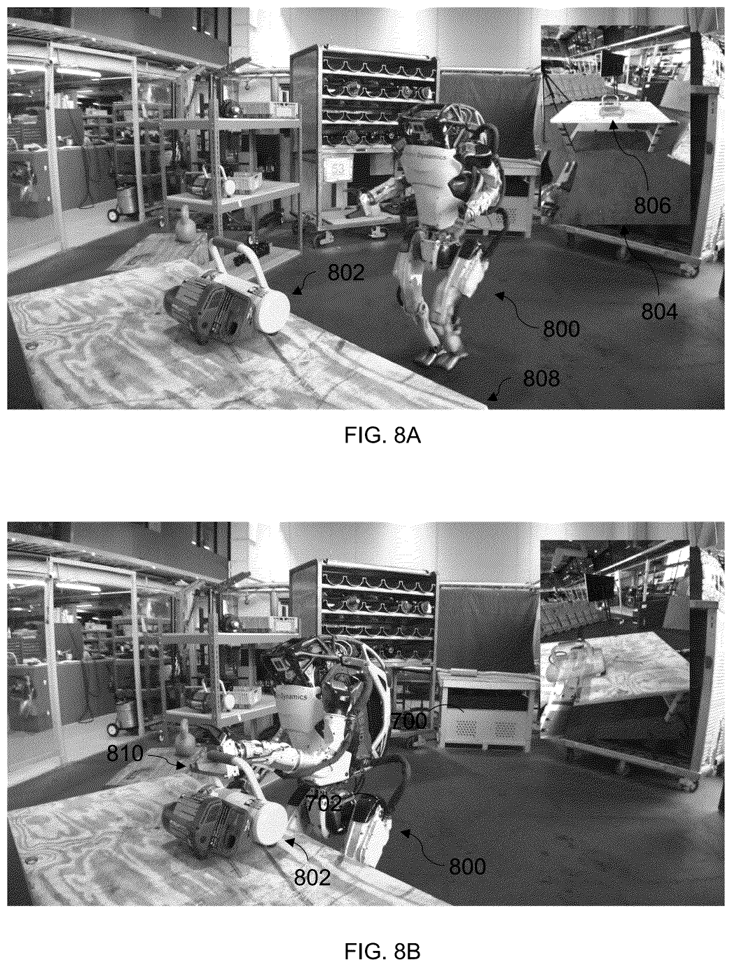

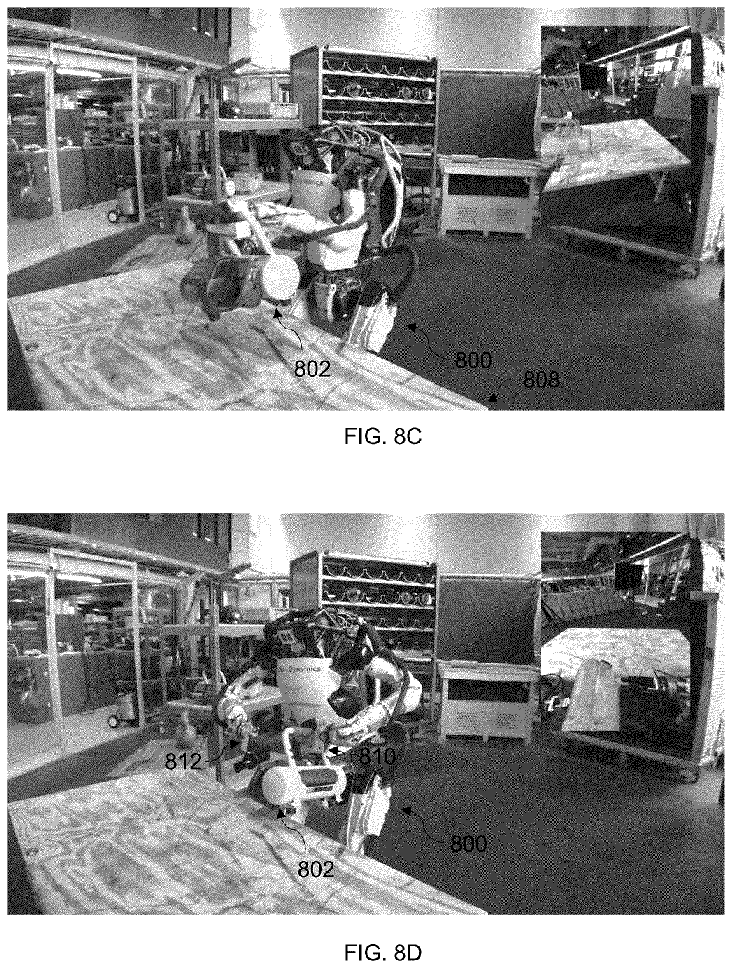

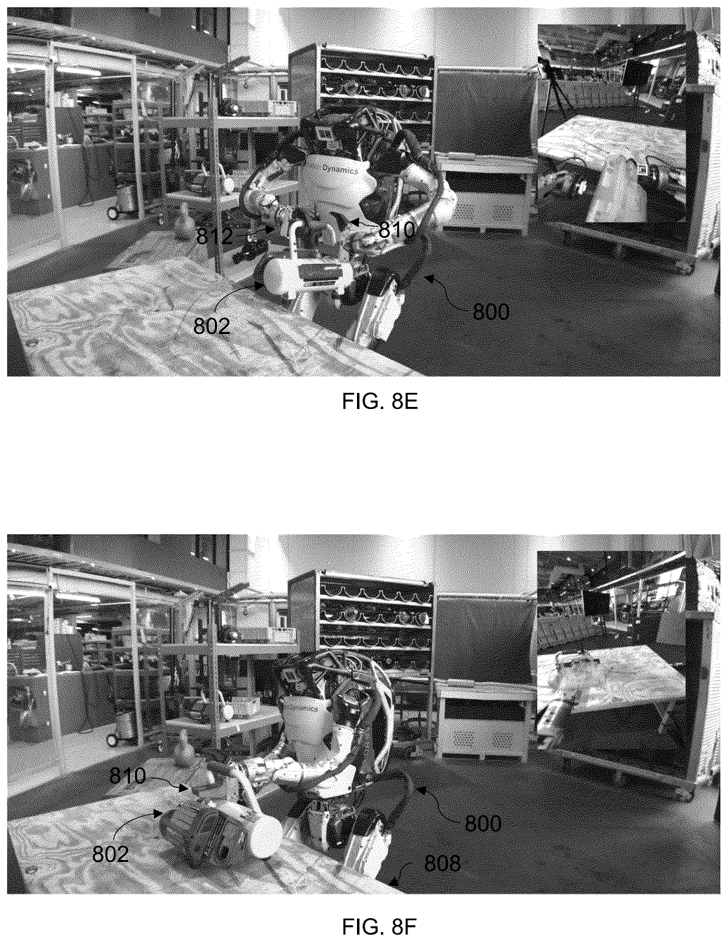

FIGS. 8A-8F are sequential views of a real-world humanoid robot 800 manipulating a compressor 802, according to an illustrative embodiment of the invention. In FIGS. 8A-8F, a picture-in-picture view 804 of a video feed provided by a perception system (e.g., a camera) of the robot 800 is superimposed on each frame. In the picture-in-picture view 804, a silhouette 806 reflecting the robot's estimation of the state (e.g., 6D pose) of the compressor 802 is superimposed over the compressor 802 itself. In FIG. 8A, the robot 800 is standing in front of the compressor 802, which is sitting on a platform 808. In FIG. 8B, the robot 800 walks toward the compressor 802 and extends a first end effector 810 to contact the compressor 802 using a grasp stance. In FIG. 8C, the robot 800 successfully grasps the compressor 802 and lifts it off the platform 808. In FIG. 8D, the robot 800 prepares to transfer the compressor 802 from the first end effector 810 to a second end effector 812. In FIG. 8E, this transfer task is completed. In FIG. 8F, the robot 800 transfers the compressor 802 back to the first end effector 810 and places the compressor 802 back onto the platform 808. The picture-in-picture view 804 in FIGS. 8A-8F shows that the robot 800 can track the state of an object (here, the compressor 802) throughout an entire manipulation sequence, which may include times when the object is not grasped (here, resting on the platform 808), when the object is grasped with one end effector, when the object is grasped with two end effectors, and when the object is partially out of view. In FIGS. 8A-8F, this object state tracking was used by the robot 800 to perform the entire behavior (e.g., the precise hand-to-hand re-grasp operation, which requires an accurate location for the handle of the compressor 802).

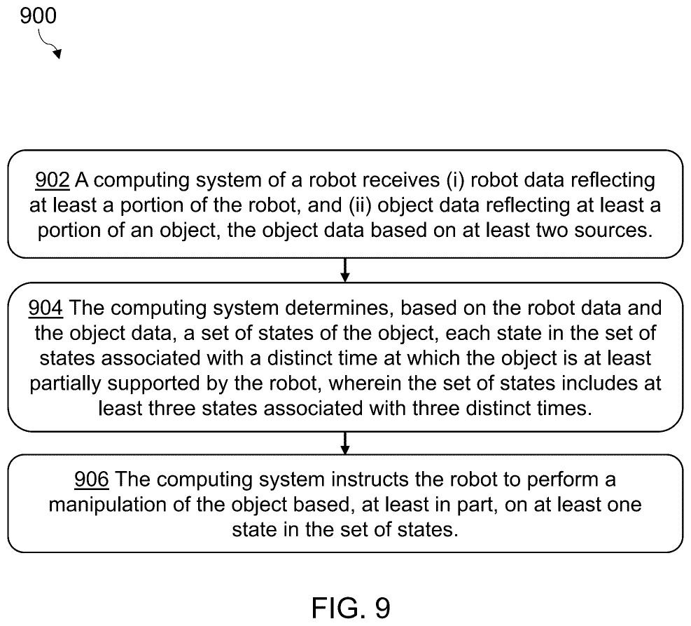

FIG. 9 is a flowchart of an exemplary computer-implemented method, according to an illustrative embodiment of the invention. In a first act 902, a computing system of a robot receives (i) robot data reflecting at least a portion of the robot, and (ii) object data reflecting at least a portion of an object, the object data based on at least two sources. In a second act 904, the computing system determines, based on the robot data and the object data, a set of states of the object, each state in the set of states associated with a distinct time at which the object is at least partially supported by the robot, wherein the set of states includes at least three states associated with three distinct times. In a third act 906, the computing system instructs the robot to perform a manipulation of the object based, at least in part, on at least one state in the set of states.

A number of implementations have been described. Nevertheless, it will be understood that various modifications may be made without departing from the spirit and scope of the disclosure.

1. A computer-implemented method comprising:
receiving, by a computing system of a robot, (i) robot data reflecting at least a portion of the robot, and (ii) object data reflecting at least a portion of an object, the object data determined based on information from at least two sources;
determining, by the computing system, based on the robot data and the object data, a set of states of the object, each state in the set of states associated with a distinct time at which the object is at least partially supported by the robot, wherein the set of states includes at least three states associated with three distinct times; and
instructing, by the computing system, the robot to perform a manipulation of the object based, at least in part, on at least one state in the set of states.

2. The method of claim 1, wherein the at least two sources include at least two of vision, kinematic, or force feedback information.

3. The method of claim 1, wherein at least one state in the set of states comprises a position and an orientation of the object.

4. The method of claim 1, wherein at least one of state in the set of states comprises a mass of the object.

5. The method of claim 1, wherein at least one state in the set of states comprises a six-dimensional pose of the object.

6. The method of claim 5, further comprising determining the six-dimensional pose of the object using a machine learning model.

7. The method of claim 1, wherein determining the set of states of the object is performed using a probabilistic model implemented in an object state estimation module of the computing system.

8. The method of claim 1, wherein determining the set of states of the object is performed using a factor graph.

9. The method of claim 1, wherein a first state in the set of states comprises a past state of the object.

10. The method of claim 1, wherein a second state in the set of states comprises a current state of the object.

11. The method of claim 1, wherein at least one state in the set of states comprises a time adjustment of object data based on at least one source, wherein the time adjustment is based on at least one of a delay associated with the at least one source or a processing time of the computing system.

12. The method of claim 1, wherein the set of states of the object includes a first state associated with a first time, and wherein determining the first state of the object comprises integrating object data received at a time after the first time.

13. The method of claim 1, wherein at least one source includes a source that provides intermittent data.

14. The method of claim 1, wherein each state in the set of states is determined relative to a global coordinate reference frame.

15. The method of claim 1 wherein each state in the set of states is determined relative to each of one or more end effectors of the robot.

16. The method of claim 1, wherein the manipulation includes at least one of grasping, re-grasping, or placing.

17. The method of claim 1, wherein determining the set of states comprises rejecting anomalous data from at least one object data source.

18. The method of claim 1, wherein determining the set of states comprises (i) determining that object data from at least one source is occluded or incomplete, and (ii) instructing action by the robot to gather additional data.

19. The method of claim 1, wherein determining the set of states comprises determining an uncertainty associated with at least one state in the set of states.

20. The method of claim 19, wherein the uncertainty is based on an estimate of a covariance of a pose of the object.

21. The method of claim 1 wherein the set of states includes at least ten states associated with ten distinct times.

22. The method of claim 1, wherein the object data reflects an interaction between the robot and the object.

23. A computing system of a robot comprising:
data processing hardware; and
memory hardware in communication with the data processing hardware, the memory hardware storing instructions that when executed on the data processing hardware cause the data processing hardware to perform operations comprising:
receiving (i) robot data reflecting at least a portion of the robot, and (ii) object data reflecting at least a portion of an object, the object data determined based on information from at least two sources;
determining, based on the robot data and the object data, a set of states of the object, each state in the set of states associated with a distinct time at which the object is at least partially supported by the robot, wherein the set of states includes at least three states associated with three distinct times; and
instructing the robot to perform a manipulation of the object based, at least in part, on at least one state in the set of states.

24. A robot comprising:
data processing hardware; and
memory hardware in communication with the data processing hardware, the memory hardware storing instructions that when executed on the data processing hardware cause the data processing hardware to perform operations comprising:
receiving (i) robot data reflecting at least a portion of the robot, and (ii) object data reflecting at least a portion of an object, the object data determined based on information from at least two sources;
determining, based on the robot data and the object data, a set of states of the object, each state in the set of states associated with a distinct time at which the object is at least partially supported by the robot, wherein the set of states includes at least three states associated with three distinct times; and
instructing the robot to perform a manipulation of the object based, at least in part, on at least one state in the set of states.
